(19) United States
(12) Patent Application Publication
(10) Pub. No.: US 2023/0379984 A1
(43) Pub. Date: Nov. 23, 2023

(54) AD-HOC RADIO BEARER AND INLINE SIGNALLING VIA MEDIUM ACCESS CONTROL

(71) Applicant: Apple Inc., Cupertino, CA (US)

(72) Inventors: Christian Hofmann, Muenchen (DE); Panagiotis Botsinis, Munich (DE); Sameh M. Eldessoki, Munich (DE); Tarik Tabet, San Jose, CA (US)

(73) Assignee: Apple Inc., Cupertino, CA (US)

(21) Appl. No.: 18/314,709

(22) Filed: May 9, 2023

Related U.S. Application Data
(60) Provisional application No. 63/344,971, filed on May 23, 2022.

(51) Int. Cl. H04W 76/10; H04W 76/30

(52) U.S. Cl. CPC H04W 76/10; H04W 76/30; H04W 84/18

(57) ABSTRACT

The present application relates to devices and components including apparatus, systems, and methods to implement ad-hoc data bearers and/or inline signalling for data radio bearers via medium access control (MAC) control elements (CEs) in wireless communication systems.

### CROSS-REFERENCE TO RELATED APPLICATIONS

This application claims priority to U.S. provisional application No. 63/344,971, entitled “Ad-hoc Radio Bearer and Inline Signalling via Medium Access Control,” filed on May 23, 2022, the disclosure of which is incorporated by reference herein in its entirety for all purposes.

### TECHNICAL FIELD

The present application relates to the field of wireless technologies and, in particular, to ad-hoc data bearers and/or inline signalling for data radio bearers via medium access control (MAC) control elements (CEs) in wireless communication systems.

### BACKGROUND

Third Generation Partnership Project (3GPP) networks provide for communication of data between user equipment and network elements (such as base stations). The data is transported by data radio bearers between the user equipment and network elements. Generally, the data radio bearers are configured with a certain configuration and change of the configuration is avoided during operation due to challenges, such as latency.

### BRIEF DESCRIPTION OF THE DRAWINGS

FIG. 1 illustrates an example signal diagram of a radio bearer (RB) reconfiguration in accordance with some embodiments.

FIG. 2 illustrates an example signal diagram showing an ad-hoc bearer setup in accordance with some embodiments.

FIG. 3 illustrates an example logical channel identifier (LCID) value table in accordance with some embodiments.

FIG. 4 illustrates an example medium access control (MAC) control element (CE) 400 in accordance with some embodiments.

FIG. 5 illustrates another example MAC CE in accordance with some embodiments.

FIG. 6 illustrates an example MAC CE in accordance with some embodiments.

FIG. 7 illustrates an example signal diagram corresponding to the MAC CE of FIG. 6 in accordance with some embodiments.

FIG. 8 illustrates an example MAC CE in accordance with some embodiments.

FIG. 9 illustrates an example signal diagram corresponding to the MAC CE of FIG. 8 in accordance with some embodiments.

FIG. 10 illustrates an example MAC CE in accordance with some embodiments.

FIG. 11 illustrates an example signal diagram corresponding to the MAC CE of FIG. 10 in accordance with some embodiments.

FIG. 12 illustrates an example MAC CE in accordance with some embodiments.

FIG. 13 illustrates an example signal diagram corresponding to the MAC CE of FIG. 12 in accordance with some embodiments.

FIG. 14 illustrates an example procedure for indicating an ad-hoc radio bearer to be configured, reconfigured, or released in accordance with some embodiments.

FIG. 15 illustrates an example procedure for configuring, reconfiguring, or releasing an ad-hoc radio bearer in accordance with some embodiments.

FIG. 16 illustrates an example user equipment (UE) in accordance with some embodiments.

FIG. 17 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signalling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

In legacy Third Generation Partnership Project (3GPP) networks, data is exchanged between user equipments (UEs) and base stations using radio bearers. The legacy radio bearers generally have defined configurations with each of the configurations having certain settings. However, a configuration for a radio bearer during operation may not be ideal for the data being transferred and it may be beneficial to change the configuration of the data bearer.

In order for a change to a configuration of a data bearer to be made during operation, both the UE and the base station exchanging the data will know the configuration of the data bearer such that data can be properly exchanged (including proper header encoding and/or decoding, and proper ciphering and/or deciphering). Making both the UE and the base station aware of the configuration of the data bearer involves communication between the UE and the base station. In legacy approaches, reconfiguration of the data radio bearer requires a service request be exchanged via non-access stratum (NAS) signalling and an execution of a radio resource control (RRC) reconfiguration. The RRC configurations can include large amounts of information, which can cause the reconfiguration of the data radio bearer to be quite expensive signalling. This NAS signalling and RRC reconfiguration can have an impact on latency and UE power consumption. Accordingly, the approaches described herein can result in a reduction of latency and UE power consumption when reconfiguring a radio bearer.

### Introduction

In sixth generation (6G), due to new services/quality of service (QoS) requirements it is anticipated that more radio bearers (RBs) with different settings may be required compared to fourth generation (4G)/fifth generation (5G) where 1 default bearer for internet and 1-2 bearers for voice over long term evolution (VoLTE)/voice over new radio (VoNR) for internet protocol multimedia subsystem (IMS) signalling and voice data is very common. Services and their requirements on the radio bearers may be more dynamic with their needs over time, hence the setup/reconfiguration and release approaches described herein may be leaner than in the legacy approaches.

In legacy approaches, a Service Request is required via non-access stratum (NAS) signalling and the execution of radio resource control (RRC) reconfiguration. The RRC reconfigurations can get huge as they contain physical layer (PHY) config (master cell group (MCG)/secondary cell group (SCG)), layer 2 (L2) config, Measurement config, so it can become quite expensive signalling, with many, also big, messages to be exchanged. This has an impact on the latency and the user equipment (UE) power consumption.

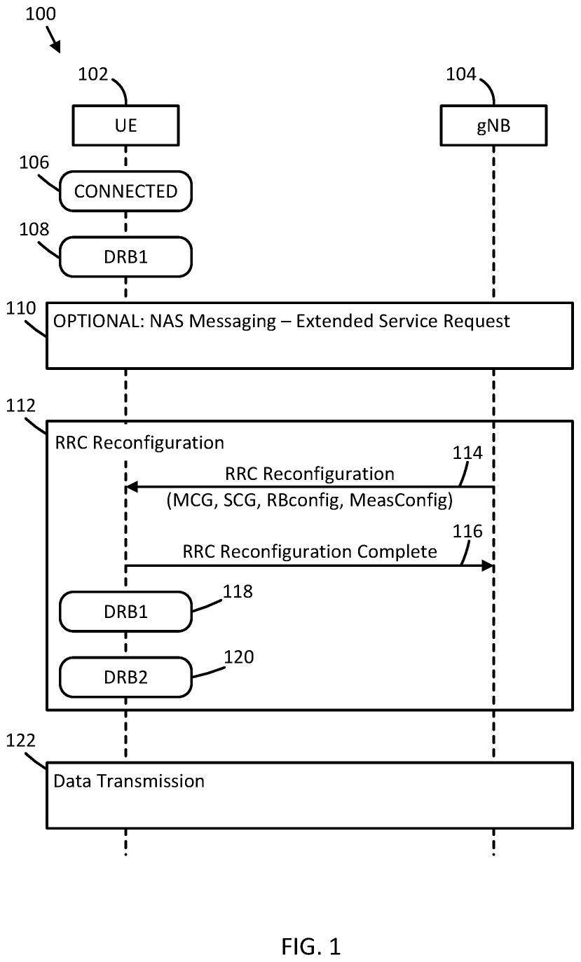

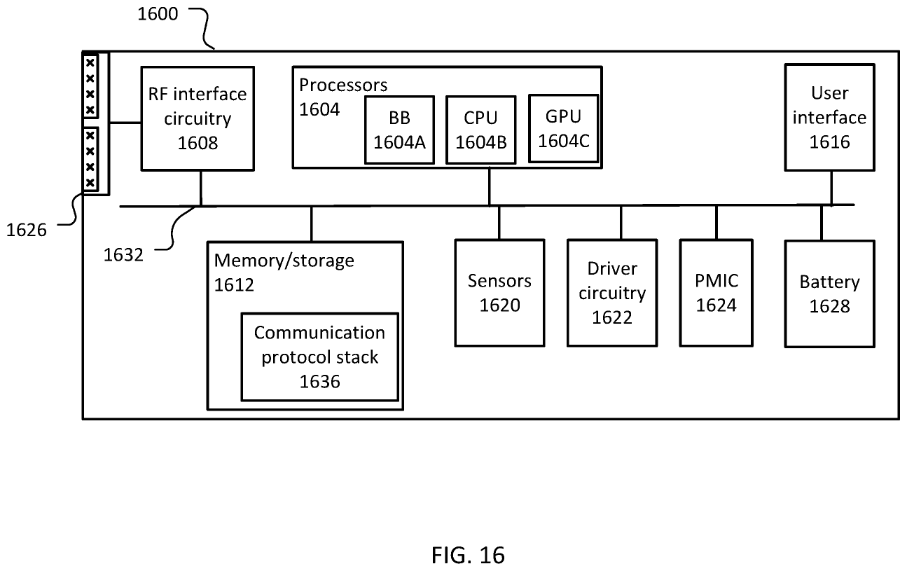

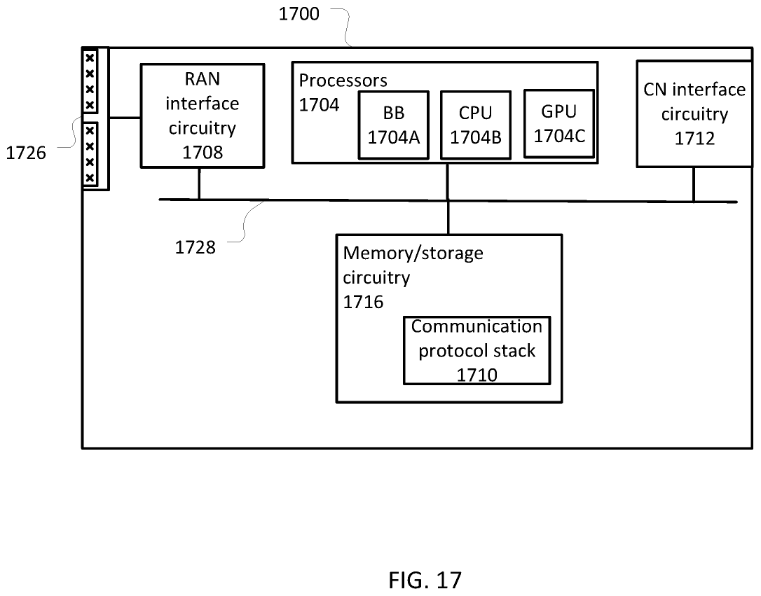

FIG. 1 illustrates an example signal diagram 100 of an RB reconfiguration in accordance with some embodiments. In particular, the signal diagram 100 illustrates example signals that may be exchanged to affect a reconfiguration of an RB for communication between a UE 102 and a base station 104 (shown as a next generation nodeB (gNB)) in the illustrated embodiment. The UE 102 may include one or more of the features of the UE 1600 (FIG. 16) and the base station 104 may include one or more of the features of the gNB 1700 (FIG. 17).

The UE 102 may be connected to the base station 104 in 106. The connection between the UE 102 and the base station 104 may allow signals to be exchanged between the UE 102 and the base station 104. In the illustrated embodiment, the UE 102 and the base station 104 may be configured to operate with a first data radio bearer (DRB) 108 (which is illustrated at DRB 1) in the illustrated embodiment at the initiation of the signalling shown in the signal diagram 100.

The UE 102 and/or the base station 104 may determine that a configuration of the RBs for transmission of data between the UE 102 and the base station 104 is to be reconfigured. Based on the determination that reconfiguration of the RBs to be performed, the UE 102 may execute a service request 110 (shown as an extended service request in the illustrated embodiment) via NAS messaging between the UE 102 and the base station 104 to request the network to change the RRC configuration. The network can trigger an RRC reconfiguration towards the UE based on the service request 110. In some embodiments, the NAS messaging may indicate settings that require a second RB and/or settings that indicate that an RB requires reconfiguration. The service request may be optional in some instances.

The UE 102 and the base station 104 may then perform an RRC reconfiguration 112 to reconfigure the DRB. In particular, the base station 104 may transmit an RRC reconfiguration message 114 to the UE 102. The RRC reconfiguration message 114 may include information related to a master cell group (MCG) a secondary cell group (SCG), an RB configuration, a measurement configuration, or some combination thereof. This information included in the RRC reconfiguration message 114 may be relatively large, which may affect latency and/or power consumption of the UE 102.

The UE 102 may reconfigure the RBs on the UE side based on the RRC reconfiguration message 114. The UE 102 may respond with an RRC reconfiguration complete message 116 once the UE 102 has completed reconfiguration of the RBs on the UE side. In the illustrated embodiment, the reconfiguration may result in reconfiguration of a first DRB 118 and setup of a second DRB 120. The base station 104 may receive the RRC reconfiguration complete message 116. In response to receiving the RRC reconfiguration complete message 116, the base station 104 may reconfigure the RBs based on the information within the RRC reconfiguration message 114.

Once both the UE 102 and the base station 104 have completed reconfiguration, the UE 102 and the base station 104 will be able to properly transmit data between the UE 102 and the base station 104 via the second DRB 120. For example, data transmission 122 is shown between the UE 102 and the base station 104 in the illustrated embodiment.

### Ad-Hoc Radio Bearers and Inline Signalling via Medium Access Control (MAC)

Setup/Reconfiguration/Release of RBs in a more dynamic fashion may be needed based on application (App)/Services requirements and the UE may setup a new data radio bearer (DRB) with different settings or reconfigure existing DRBs with different settings in order to adapt to new requirements more dynamically. For example, the approaches herein may allow for setup, reconfiguration, and/or release of RBs in a dynamic fashion as compared to legacy approaches. The UE may determine different settings and/or configurations for DRBs based on data related to applications and/or services to be exchanged between a UE and a base station. The UE may setup or reconfigure DRBs according to the determined different settings and/or configurations for the DRBs.

For example, some new requirements may appear, for example in terms of quality of service (QoS) requirements, App end-to-end latency, Privacy/security needs, Small/medium/large amounts of data to be sent, Congestion situation, using transmission (TX)/reception (RX) window information on different levels, Offloading capabilities, and/or radio frequency (RF) conditions like cell edge, packet loss rates. The UE may take these requirements into account when determining settings and/or configurations for a DRB. These requirements may be referred to as DRB configuration considerations throughout this disclosure.

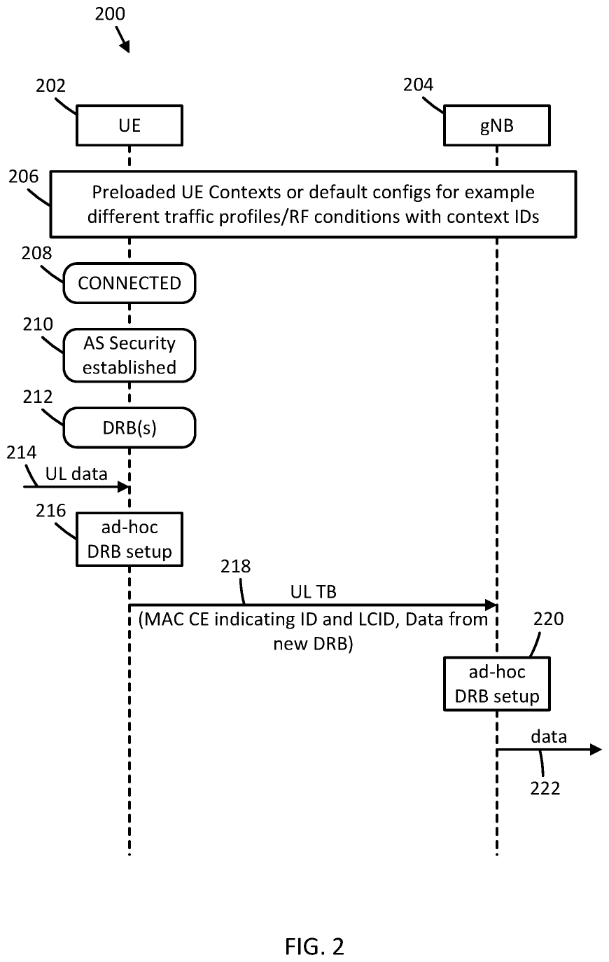

Ad-Hoc Bearers and Inline Signalling can be an addition to regular DRBs. For example, the ad-hoc bearers and/or inline signalling approaches described herein may be implemented in addition to legacy approaches for DRB reconfiguration. The approach is to start with only the best effort bearer (as long as this serves the purpose of all current services). For example, the UE and base station may be initiated with the best effort type bearer. If buffers get filled due to heavy background traffic, or requirements change, adaptation of the settings of the best effort bearer or opening up a new DRB one quickly (inline) might be needed to overcome this situation (see signal diagram 200 (FIG. 2)). Those settings can be communicated inline, within the transport block (TB) towards the network (NW) via a newly defined Context identifier (ID). Based on that the NW can establish/reconfigure the RB accordingly in order to be able to decode the TB correctly.

FIG. 2 illustrates an example signal diagram 200 showing an ad-hoc bearer setup in accordance with some embodiments. For example, the signal diagram 200 illustrates operations and signals that may be implemented for setting up an ad-hoc bearer, which may be configured inline. The operations and signals may be performed by and/or signalled between a UE 202 and a base station 204. The UE 202 may include one or more of the features of the UE 102 (FIG. 1) and/or UE 1600 (FIG. 16). Further, the base station 204 may include one or more of the features of the base station 104 (FIG. 1) and/or the gNB 1700 (FIG. 17).

The UE 202 and the base station 204 may be preloaded with UE contexts and/or default configurations, as illustrated by 206. The preloaded UE contexts and/or default configurations may be for different traffic profiles and/or different radio frequency (RF) conditions. Each of the UE contexts and/or default configurations preloaded on the UE 202 and the base station 204 may be associated with corresponding context IDs. A UE context and/or default configuration stored on the UE 202 may be associated with a same context ID as the UE context and/or default configuration stored on the base station 204, such that the UE 202 and the base station 204 will both identify the same UE context and/or default configuration when provided with the same context ID.

The UE 202 may be connected to the base station 204, as illustrated by 208. Further, the UE 202 may have access stratum (AS) security established, as illustrated by 210. The 202 may have one or more DRBs 212 configured. In some embodiments, the one or more DRBs 212 may comprise a best effort type bearer.

The UE 202 may generate and/or receive uplink (UL) data 214. For example, the UL data 214 may be produced by one or more applications and/or services operating on the 202. The UE 202 may generate the UL data 214 during execution of the applications and/or services, or may receive the UL data 214 from the applications or the services. The UL data 214 may be data to be exchanged with the base station 204 for operation of the applications and/or services. The UE 202 may determine a configuration and/or one or more settings for DRBs to transmit the UL data to the base station 204. For example, the UE 202 may determine the configuration and/or one or more settings for DRBs based on the DRB configuration considerations.

The UE 202 may perform an ad-hoc DRB setup in 216. For example, the UE 202 may configure one or more DRBs at the UE side. The UE 202 may configure the one or more DRBs in accordance with the determined configuration and/or one or more settings for DRBs based on the UL data 214. The UE 202 may be aware of proper arrangement and header encoding and ciphering of the data sent via a DRB being setup by the ad-hoc DRB setup in 216.

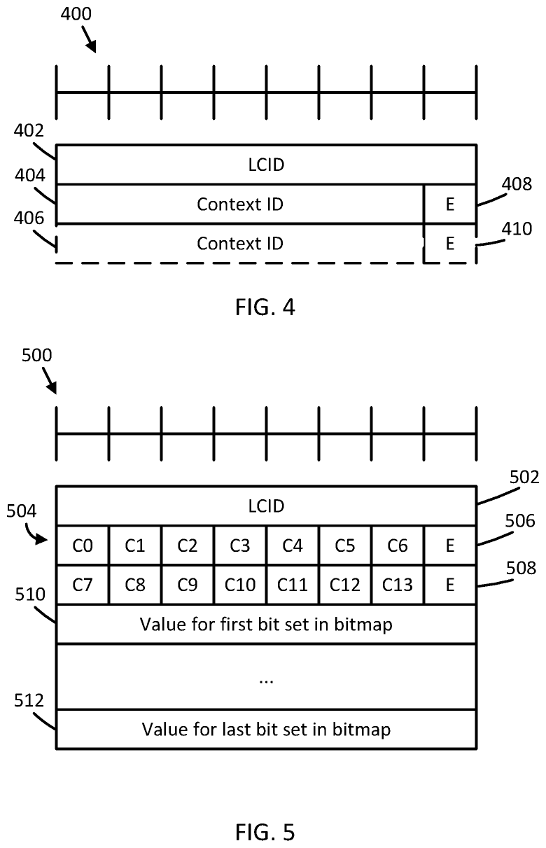

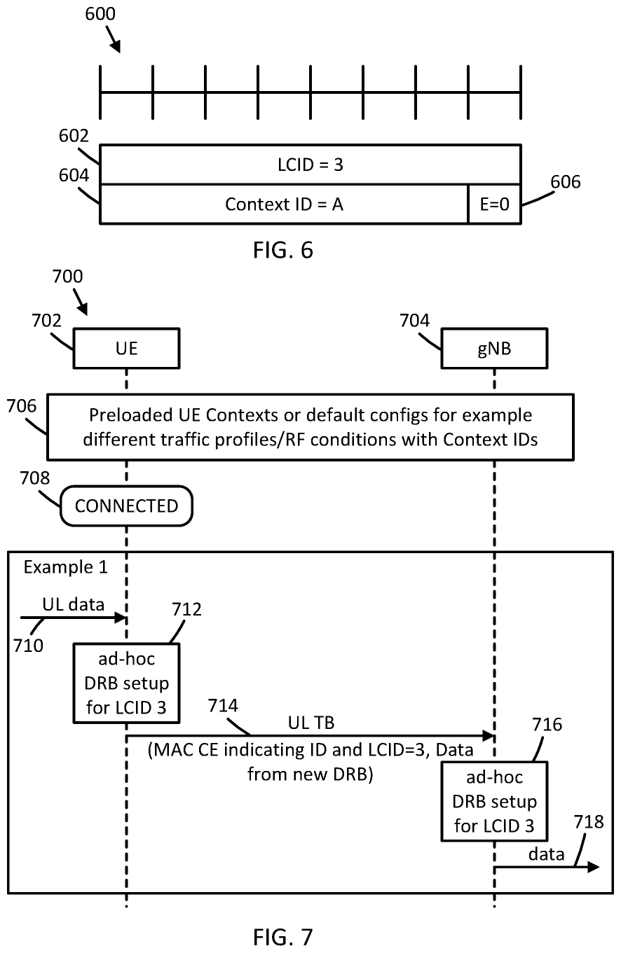

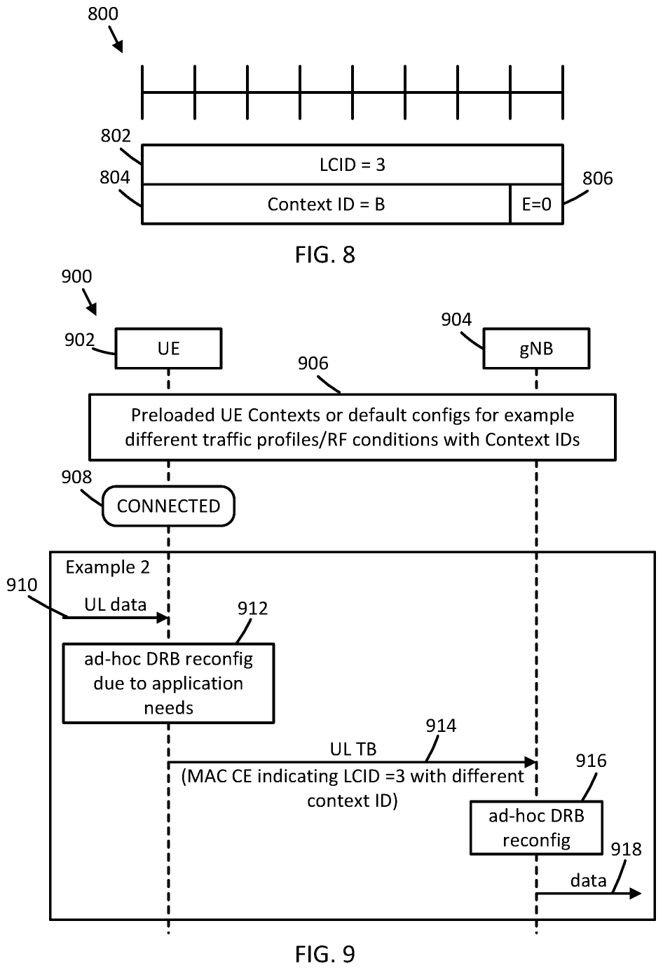

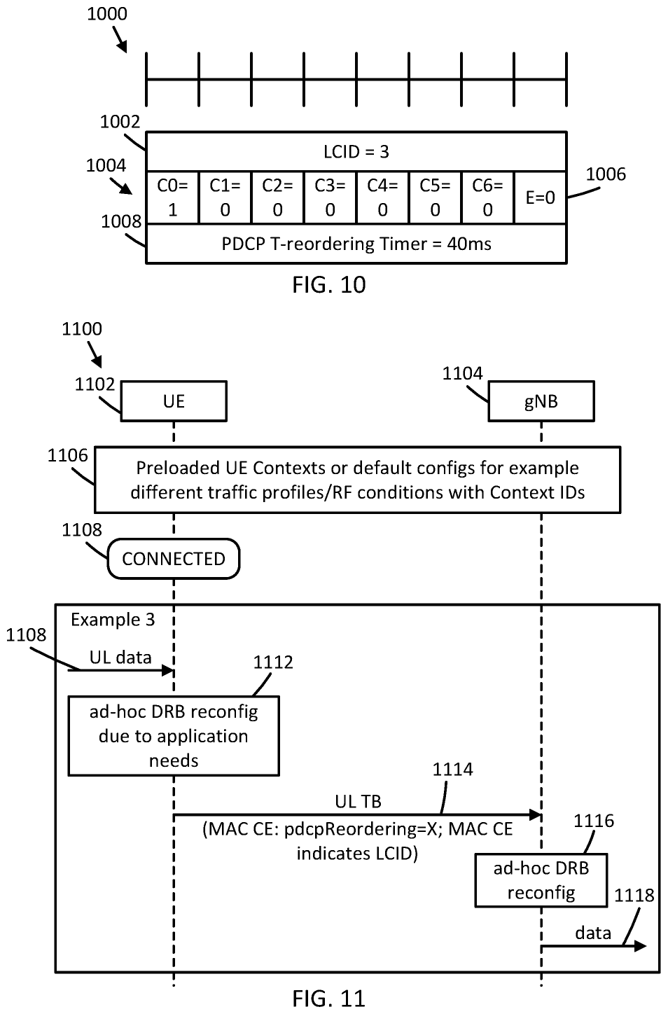

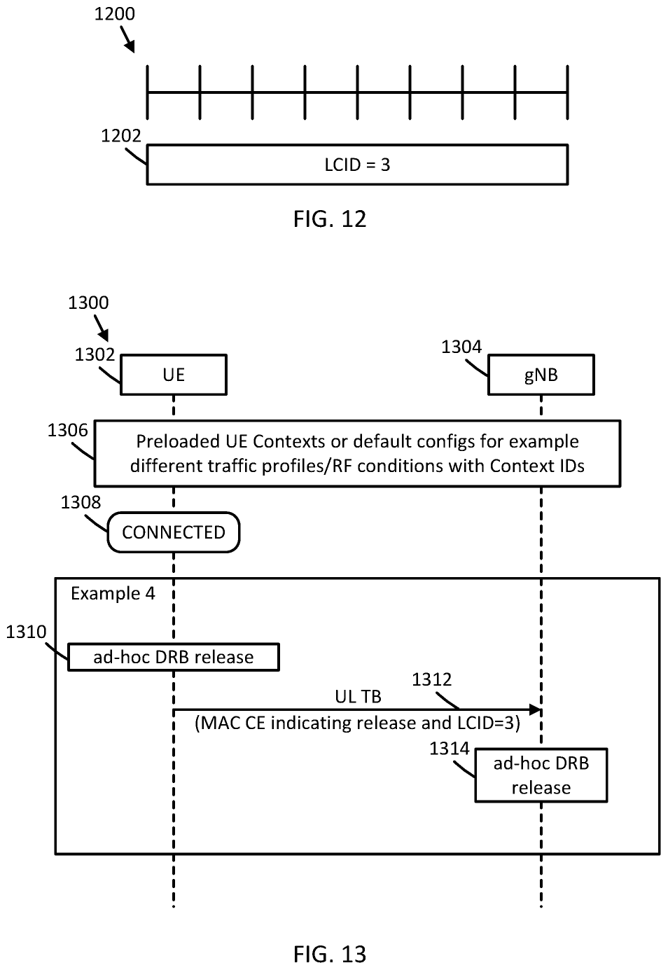

The UE 202 may transmit a UL TB 218 to the base station 204. The UL TB 218 may include a MAC control element (CE) (such as the MAC CE 400 (FIG. 4), the MAC CE 500 (FIG. 5), the MAC CE 600 (FIG. 6), the MAC CE 800 (FIG. 8), the MAC CE 1000 (FIG. 10), and/or the MAC CE 1200 (FIG. 12). The MAC CE may indicate the configuration and/or settings for the DRB that was setup on the UE side in 216. The UL TB 218 may further include the UL data 214. Utilizing the MAC CE to indicate the configuration and/or settings to the base station 204 to configure, reconfigure, or release the ad-hoc DRB can reduce latency as compared to legacy approaches of DRB reconfiguration.

The base station 204 may receive the UL TB 218 from the UE 202. The base station 204 may determine a configuration and/or settings for the DRB based on the UL TB 218. For example, the base station 204 may determine the configuration and/or settings for the DRB based on the MAC CE included in the UL TB 218. The base station 204 may perform an ad-hoc DRB setup 220 to setup a DRB in accordance with the configuration and/or settings determined from the MAC CE on the base station side.

The base station 204 may then utilize the configured DRB from the ad-hoc DRB setup 220 to process the data from the UL TB 218. For example, the base station 204 may decode the headers as per the newly established DRB configuration and perform deciphering of the data received in the UL TB 218 to produce data 222. The base station 204 may further provide the data 222 to one or more other network elements (such as a core network). The same scheme as shown in UL here may apply in downlink (DL) controlled by the NW.

New MAC CEs for inline signalling using Reserved logical channel identifier (LCD) 35-44. For example, the approaches with MAC CEs may utilize LCIDs that were reserved in legacy systems.

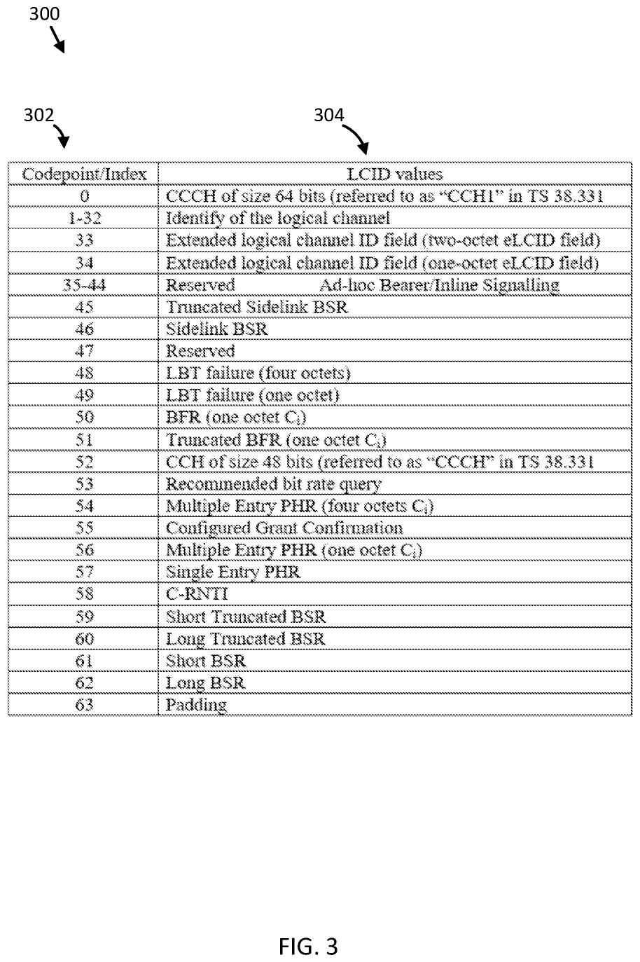

FIG. 3 illustrates an example LCID value table 300 in accordance with some embodiments. In particular, the LCID value table 300 illustrates codepoint/index values 302 (referred to herein as “index values 302”) and LCID values 304 corresponding to the index values 302. As can be seen from the LCID value table 300, index values 302 of 35 through 44 had been reserved for corresponding LCID values 304. One or more of index values 302 of 35 through 44 may be utilized for ad-hoc bearer and/or inline signalling disclosed herein. For example, the index values 302 of one or more of 35 through 44 may be utilized for the MAC CEs described herein.

Herein presented are example MAC CEs for DRB setup/reconfig/release. For example, the MAC CEs described herein may be utilized for setup of DRBs, reconfiguration of DRBs, or release of DRBs. The example MAC CEs may be included in the UL TB 218 (FIG. 2), where the MAC CEs may indicate information for one or more ad-hoc DRBs to be setup.

FIG. 4 illustrates an example MAC CE 400 in accordance with some embodiments. For example, the MAC CE 400 may be transmitted by an originating device to a receiving device to indicate one or more DRBs to be setup, reconfigured or released. As an example, the MAC CE 400 may be included in the UL TB 218 (FIG. 2) transmitted from the UE 202 (FIG. 2) (the originating device in the embodiment) to the base station 204 (FIG. 2) (the receiving device in the embodiment), where the MAC CE 400 may indicate a configuration of a DRB being utilized to transmit data in the UL TB 218.

The MAC CE 400 may include an LCID field 402. The LCID field 402 may indicate an identity of a logical channel (LC) to be setup, reconfigured or released based on the MAC CE 400. For example, LCID may indicate an identity of the LC to be setup/reconfig/released.

The MAC CE 400 may further include one or more context ID fields. For example, the MAC CE 400 includes a first context ID field 404 and a second context ID field 406 in the illustrated embodiment. The context ID fields may indicate preconfigured DRB settings to be utilized for a DRB to be setup, reconfigured or released. For example, Context ID: ID of the preconfigured DRB settings to be used. UEs and base stations within a network may be preconfigured with DRB settings for different configurations, where a context ID within a context field may indicate one of the preconfigured configurations with preconfigured DRB settings. Each of the context ID fields may correspond to a DRB to be setup, reconfigured or released. For example, the first context ID field 404 may correspond to a first DRB to be setup, reconfigured or released and the second context ID field 406 may correspond to a second DRB to be setup, reconfigured or released.

The MAC CE 400 may further include one or more extension flags. For example, the MAC CE 400 includes a first extension flag 408 and a second extension flag 410 in the illustrated embodiment. Each of the extension flags may correspond to a corresponding context ID field. For example, the first extension flag 408 corresponds to the first context ID field 404 and the second extension flag 410 corresponds to the second context ID field 406. The extension flags may indicate whether another context ID field follows the corresponding context ID field. For example, the first extension flag 408 indicates whether another context ID field follows the corresponding first context ID field 404 and the second extension flag 410 indicates whether another context ID field follows the corresponding second context ID field 406 in the illustrated embodiment. In some embodiments, Extension Flag value of 0 indicates MAC CE ends and/or no context ID fields follow the corresponding context ID field and an Extension Flag value of 1 indicates Another ContextID octet is following. In the illustrated embodiment, the second context ID field 406 and the second extension flag 410 are indicated in dashed lines to indicate the inclusion of the second context ID field 406 and the second extension flag 410 being included in the MAC CE 400 may depend on a value of the first extension flag 408.

The MAC CE 400 may be transmitted associated with an index value, such as one of the index values of the index values 302 (FIG. 3). For example, the MAC CE 400 may be transmitted associated with one of the index values from 35 through 44. In some embodiments, the index value associated with the MAC CE 400 may indicate whether the MAC CE 400 is for setup of one or more DRBs, reconfiguration of one or more DRBs, or release of one or more DRBs.

While two context ID fields and two extension flags are shown in the illustrated embodiment, it should be understood that more or less context ID fields and extension flags may be included in the MAC CE 400 in other embodiments. For example, there may be one or more context ID fields and extension flags in other embodiments. The extension flags may indicate whether additional context ID fields and additional extension flags are included within the MAC CE 400.

FIG. 5 illustrates another example MAC CE 500 in accordance with some embodiments. In particular, FIG. 5 illustrates an example MAC CE 500 for small delta (re-) configurations. The MAC CE 500 for small delta configurations and/or reconfigurations may allow particular parameters of a DRB to be configured or reconfigured without having to define a complete configuration for the DRB.

The MAC CE 500 may include an LCID field 502. The LCID field 502 may indicate an identity of an LC to be setup, reconfigured or released based on the MAC CE 500. For example, LCID may indicate an identity of the LC to be setup/reconfig/released.

The MAC CE 500 may include one or more parameter fields 504. The parameter fields 504 may form a bitmap in some embodiments. The MAC CE 500 includes parameter fields 504 C0 through C13 in the illustrated embodiment. For example, each of the parameter fields 504 may be associated with a corresponding parameter, where a parameter field can indicate whether the corresponding parameter is to be configured or reconfigured. For example, C0 . . . C6 may comprise a bitmap indicating the presence of certain parameters, e.g., C0 may indicate packet data convergence protocol (PDCP) T-Reordering, if set to “1” it requires 1 octet in the same MAC CE for indicating the timer value in milliseconds (ms). C1 may indicate radio link control (RLC) T-Reassembly, if set to “1” it requires 1 octet for the timer value in ms. C2 may indicate RLC acknowledged mode (AM), if set to “1” it requires 1 octet in the same MAC CE for indicating sequence number (SN) Size.

The MAC CE 500 may include one or more extension flags. For example, the MAC CE 500 includes a first extension flag 506 and a second extension flag 508 in the illustrated embodiment. Each of the extension flags may correspond to a corresponding set of parameter fields 504. In some examples, the parameter fields may be grouped into sets of seven parameter fields, where one set is one row of the bitmap. The first extension flag 506 corresponds to parameter fields C0 through C6 and the second extension flag 508 corresponds to parameter fields C7 through C13. The extension flags may indicate whether additional parameter fields follow the corresponding set of parameter fields. For example, the first extension flag 506 indicates whether additional parameter fields follow the corresponding parameters C0 through C6 and the second extension flag 508 indicates whether additional parameter fields follow the corresponding parameters C7 through C13 in the illustrated embodiment. In some embodiments, Extension Flag value of 0 indicates bitmap ends and/or no additional parameter fields follow the corresponding parameter fields and an Extension Flag value of 1 indicates another bitmap octet is following.

The MAC CE 500 may further include one or more value fields. For example, the MAC CE 500 includes a first value field 510 and a second value field 512 in the illustrated embodiment. Each of the value fields may be associated with a corresponding parameter field. In some embodiments, each of the value fields included in the MAC CE 500 may correspond to a parameter field to be configured or reconfigured. The value fields may be arranged in order, such that the first value field in the MAC CE 500 corresponds to the first parameter field to be configured or reconfigured. For example, the first value field 510 may correspond to a first parameter field to be configured or reconfigured and the second value field 512 may correspond to a last parameter field in the illustrated embodiment.

The MAC CE 500 may be transmitted associated with an index value, such as one of the index values of the index values 302 (FIG. 3). For example, the MAC CE 500 may be transmitted associated with one of the index values from 35 through 44. In some embodiments, the index value associated with the MAC CE 500 may indicate whether the MAC CE 500 is for configuration of one or more DRBs or reconfiguration of one or more DRBs.

While 14 parameter fields and two extension flags are shown in the illustrated embodiment, it should be understood that more or less parameter fields and extension flags may be included in the MAC CE 400 in other embodiments. For example, there may be one or more parameter fields and extension flags in other embodiments. The extension flags may indicate whether additional parameters fields and additional extension flags are included within the MAC CE 400.

A first example (referred to as Example 1) of DRB Setup via MAC CE is described herein. FIG. 6 illustrates an example MAC CE 600 in accordance with some embodiments. FIG. 7 illustrates an example signal diagram 700 corresponding to the MAC CE 600 of FIG. 6 in accordance with some embodiments. The MAC CE 600 and the signal diagram 700 illustrates the first example in accordance with some embodiments.

The DRB setup example may occur between a UE 702 and a base station 704. In the illustrated embodiment, the UE 702 may originate the DRB configuration of example 1 and the base station 704 may receive information from the UE 702 for configuration of the DRB. The UE 702 and the base station 704 may have preloaded UE contexts and/or default configurations stored as indicated by 706. The preloaded UE contexts and/or default configurations may be for different traffic profiles and/or RF conditions. Each of the UE contexts and/or default configurations preloaded on the UE 702 and the base station 704 may be associated with corresponding context IDs. A UE context and/or default configuration stored on the UE 702 may be associated with a same context ID as the UE context and/or default configuration stored on the base station 704, such that the UE 702 and the base station 704 will both identify the same UE context and/or default configuration when provided with the same context ID. The UE 702 may be connected to the base station 704 as indicated by 708.

The UE 702 may be operating an application or providing a service which may generate UL data 710, or may receive the UL data 710 from an application or a service. The UE 702 may determine a configuration and/or settings for a DRB to carry the UL data 710 based on the UL data 710. For example, the UE 702 may determine the configuration and/or settings for the DRB based on DRB configuration considerations related to the UL data 710. In the illustrated embodiment, the UE 702 may determine that the DRB is to be configured with a preloaded configuration corresponding to a value of A.

The UE 702 may perform an ad-hoc DRB setup 712 to configure a DRB at the UE side for transporting the UL data 710. The UE 702 may configure the DRB at the UE side in accordance with the configuration and/or settings determined by the UE 702 for the DRB. In the illustrated example, the UE 702 may configure the DRB with the preloaded configuration corresponding to the value of A based on the determination.

The UE 702 may generate the MAC CE 600 to indicate to the base station 704 the configuration for the DRB. The MAC CE 600 may include one or more of the features of the MAC CE 400 (FIG. 4). The UE 702 indicates a “MAC CE for setup” indicating new LCID=3 with a preloaded ContextID A in the illustrated example. For example, the MAC CE 600 may include an LCID field 602 set to a value of 3. The LC corresponding to the LCID value of 3 may correspond to the DRB. Accordingly, the MAC CE 600 indicates that the configuration of DRB in the illustrated example is to be for the LC corresponding to the LCID value of 3.

Further, the MAC CE 600 may include a context ID field 604. The context ID field 604 may indicate a value of A in the illustrated embodiment to indicate that the DRB is to be configured with the configuration corresponding to the value of A.

The MAC CE 600 may further include an extension flag 606. The extension flag 606 may correspond to the context ID field 604. The extension flag 606 may indicate whether any context ID fields follow the context ID field 604. In the illustrated example, the extension flag 606 may be set with a value of 0 to indicate that no other context IDs follow the context ID field 604.

The UE 702 may transmit the MAC CE 600 with the UL data 710 on a UL TB 714 to the base station 704. The UL data 710 may be arranged and/or encoded in accordance with the configuration corresponding to the value of A for the DRB when transmitted in the UL TB 714. Accordingly, the MAC CE 600 may indicate the configuration of the DRB transporting the UL data 710. Accordingly, the indication of the configuration of the DRB may be transported in the same UL TB 714 as the data to which the configuration of the DRB is to apply.

The base station 704 may receive the UL TB 714 from the UE 702. The base station 704 may identify the MAC CE 600 within the UL TB 714 and determine the configuration for the DRB from the MAC CE 600. In the illustrated example, the base station 704 may determine that the DRB is to be configured with the configuration corresponding to the value of A based on the MAC CE 600.

The base station 704 may perform an ad-hoc DRB setup 716 to configure the base station side with the determined configuration. For example, the NW sets up an ad-hoc DRB for LCID=3 with the setting of ContextID A. The base station 704 may configure the DRB with the preloaded configuration corresponding to the value A in the illustrated embodiment. The base station 704 may retrieve the configuration from memory to configure the DRB.

The base station 704 may utilize the configuration of the DRB to process the UL data 710 received in the UL TB 714. For example, the base station 704 may decode the UL data 710 in accordance with the configuration of the DRB to produce data 718. The base station 704 may provide the data 718 to another of the network elements, such as the core network.

A second example (referred to as Example 2) of DRB Reconfiguration via MAC CE is described herein. FIG. 8 illustrates an example MAC CE 800 in accordance with some embodiments. FIG. 9 illustrates an example signal diagram 900 corresponding to the MAC CE 800 of FIG. 8 in accordance with some embodiments. The MAC CE 800 and the signal diagram 900 illustrates the second example in accordance with some embodiments. The DRB reconfiguration illustrated may be reconfiguration of the DRB that was setup in Example 1.

The DRB reconfiguration example may occur between a UE 902 and a base station 904. The UE 902 may include one or more of the features of, or may comprise, the UE 702 (FIG. 7). Further, the base station 904 may include one or more of the features of, or may comprise, the base station 704 (FIG. 7). In the illustrated embodiment, the UE 902 may originate the DRB reconfiguration of example 2 and the base station 904 may receive information from the UE 902 for reconfiguration of the DRB. The UE 902 and the base station 904 may have preloaded UE contexts and/or default configurations stored as indicated by 906. The preloaded UE contexts and/or default configurations may be for different traffic profiles and/or RF conditions. Further, the preloaded UE contexts and/or default configurations may include secure IDs. The UE 902 may be connected to the base station 904 as indicated by 908.

The UE 902 may be operating an application or providing a service which may generate UL data 910, or may receive the UL data 910 from an application or a service. The UE 902 may determine a configuration and/or settings for a DRB to carry the UL data 910 based on the UL data 910. For example, the UE 902 may determine the configuration and/or settings for the DRB based on DRB configuration considerations related to the UL data 910. In the illustrated embodiment, the UE 902 may determine that the DRB is to be configured with a preloaded configuration corresponding to a value of B. As the UE 902 is aware that the DRB has already been setup, the UE 902 may determine that the DRB is to be reconfigured.

The UE 902 may perform an ad-hoc DRB reconfiguration 912 to reconfigure a DRB at the UE side for transporting the UL data 910. The UE 902 may reconfigure the DRB at the UE side in accordance with the configuration and/or settings determined by the UE 902 for the DRB. In the illustrated example, the UE 902 may configure the DRB with the preloaded configuration corresponding to the value of B based on the determination.

The UE 902 may generate the MAC CE 800 to indicate to the base station 904 the reconfiguration for the DRB. The MAC CE 800 may include one or more of the features of the

MAC CE 400 (FIG. 4). The UE 902 indicates a “MAC CE for reconfiguration” for already existing LCID=3, but with a different preloaded ContextID B in the illustrated example. For example, the MAC CE 800 may include an LCID field 802 set to the value of 3. The LC corresponding to LCID value 3 may correspond to the DRB. Accordingly, the MAC CE 800 indicates that the configuration of DRB in the illustrated example is to be for the LC corresponding to the LCID value of 3.

Further, the MAC CE 800 may include a context ID field 804. The context ID field 804 may indicate a value of B in the illustrated embodiment to indicate that the DRB is to be configured with the configuration corresponding to the value of B.

The MAC CE 800 may further include an extension flag 806. The extension flag 806 may correspond to the context ID field 804. The extension flag 806 may indicate whether any context ID fields follow the context ID field 804. In the illustrated example, the extension flag 806 may be set with a value of 0 to indicate that no other context IDs follow the context ID field 804.

The UE 902 may transmit the MAC CE 800 with the UL data 910 on a UL TB 914 to the base station 904. The UL data 910 may be arranged and/or encoded in accordance with the configuration corresponding to the value of B for the DRB when transmitted in the UL TB 914. Accordingly, the MAC CE 800 may indicate the configuration of the DRB transporting the UL data 910. Accordingly, the indication of the configuration of the DRB may be transported in the same UL TB 914 as the data to which the configuration of the DRB is to apply.

The base station 904 may receive the UL TB 914 from the UE 902. The base station 904 may identify the MAC CE 800 within the UL TB 914 and determine the configuration for the DRB from the MAC CE 800. In the illustrated example, the base station 904 may determine that the DRB is to be configured with the configuration corresponding to the value of B based on the MAC CE 800.

The base station 904 may perform an ad-hoc DRB reconfiguration 916 to configure the base station side with the determined configuration. For example, the NW reconfigures the DRB for LCID=3 with the setting of ContextID B. The base station 904 may configure the DRB with the preloaded configuration corresponding to the value B in the illustrated embodiment. The base station 904 may retrieve the configuration from memory to configure the DRB.

The base station 904 may utilize the configuration of the DRB to process the UL data 910 received in the UL TB 914. For example, the base station 904 may decode the UL data 910 in accordance with the configuration of the DRB to produce data 918. The base station 904 may provide the data 918 to another of the network elements, such as the core network.

A third example (referred to as Example 3) of small delta (re-)configurations can be done via dedicated MAC CE. FIG. 10 illustrates an example MAC CE 1000 in accordance with some embodiments. FIG. 11 illustrates an example signal diagram 1100 corresponding to the MAC CE 1000 of FIG. 10 in accordance with some embodiments. The MAC CE 1000 and the signal diagram 1100 illustrates the third example in accordance with some embodiments. The DRB reconfiguration illustrated may be reconfiguration of the DRB that was setup in Example 1 and/or Example 2.

The DRB reconfiguration example may occur between a UE 1102 and a base station 1104. The UE 1102 may include one or more of the features of, or may comprise, the UE 702 (FIG. 7) and/or the UE 902 (FIG. 9). Further, the base station 1104 may include one or more of the features of, or may comprise, the base station 704 (FIG. 7) and/or the UE 902 (FIG. 9). In the illustrated embodiment, the UE 1102 may originate the DRB reconfiguration of example 3 and the base station 1104 may receive information from the UE 1102 for reconfiguration of the DRB. The UE 1102 and the base station 1104 may have preloaded UE contexts and/or default configurations stored as indicated by 1106. The preloaded UE contexts and/or default configurations may be for different traffic profiles and/or RF conditions. Each of the UE contexts and/or default configurations preloaded on the UE 702 and the base station 704 may be associated with corresponding context IDs. A UE context and/or default configuration stored on the UE 702 may be associated with a same context ID as the UE context and/or default configuration stored on the base station 704, such that the UE 702 and the base station 704 will both identify the same UE context and/or default configuration when provided with the same context ID. The UE 1102 may be connected to the base station 1104 as indicated by 1108.

The UE 1102 may be operating an application or providing a service which may generate UL data 1110, or may receive the UL data 1110 from an application or a service. The UE 1102 may determine a configuration and/or settings for a DRB to carry the UL data 1110 based on the UL data 1110. For example, the UE 1102 may determine the configuration and/or settings for the DRB based on DRB configuration considerations related to the UL data 1110. In the illustrated embodiment, the UE 1102 may determine settings that the DRB is to be reconfigured. The UE 1102 may compare current settings of the DRB with determined settings for the DRB to determine whether any of the settings are to be updated. In the illustrated embodiment, the UE 1102 may determine that that the PDCP T-reordering timer parameter is to be reconfigured to 40 milliseconds (ms) based on the UL data 1110.

The UE 1102 may perform an ad-hoc DRB reconfiguration 1112 to reconfigure a DRB at the UE side for transporting the UL data 1110. The UE 1102 may reconfigure the DRB at the UE side based on the determined settings to be updated. For example, the UE may reconfigure the DRB to have the PDCP T-reordering timer parameter to 40 ms in the illustrated embodiment.

The UE 1102 may generate the MAC CE 1000 to indicate to the base station 1104 the configuration of the DRB. The MAC CE 1000 may include one or more of the features of the MAC CE 500 (FIG. 5). The UE 1102 may generate the MAC CE 1000 to indicate to the base station 1104 the settings to be updated for the DRB. The UE 1102 indicates “MAC CE for parameter reconfiguration” for LCID=3 with the bitmap set to C0=1, C1 . . . C6=0, E=0, indicating that there is a new PDCP T-reordering value (bit C0) with a corresponding value field indicating the actual timer setting (40 ms) in the illustrated embodiment. For example, the MAC CE 1000 may include an LCID field 1002 set to the value of 3. The LC corresponding to LCID value 3 may correspond to the DRB. Accordingly, the MAC CE 1000 indicates that the configuration of DRB in the illustrated example is to be for the LC corresponding to the LCID value of 3.

Further, the MAC CE 1000 may include one or more parameter fields 1004. The one or more parameter fields 1004 include parameter fields C0 through C6 in the illustrated example. Each of the parameter fields may correspond to a different corresponding parameter. For example, the C0 parameter field may correspond to the PDCP T-reordering timer parameter in the illustrated embodiment. The values of the parameter fields may indicate whether the corresponding parameter is to be reconfigured. In some embodiments, a parameter field assigned a value of 1 may indicate that the corresponding parameter is to be reconfigured and a parameter field assigned a value of 0 may indicate that the corresponding parameter is not to be reconfigured. In the illustrated embodiment, the C0 parameter field is assigned a value of 1 while the C1 through C6 parameter fields are assigned a value of 0. Accordingly, the MAC CE 1000 may indicate that the PDCP T-reordering time parameter is to be reconfigured while the rest of the parameters are not to be reconfigured in the illustrated example.

The MAC CE 1000 may further include an extension flag 1006. The extension flag 1006 may correspond to the parameter fields C0 through C6. The extension flag 1006 may indicate whether parameter fields follow the C0 through C6 parameter fields. In the illustrated example, the extension flag 1006 may be set with a value of 0 to indicate that no other parameter fields follow the C0 through C6 parameter fields in the MAC CE 1000.

The MAC CE 1000 may further include one or more value fields. For example, the MAC CE 1000 includes value field 1008. The value fields may correspond to the parameters to be reconfigured, where a first value field may correspond to a first parameter to be reconfigured and so forth. In the illustrated embodiment, the value field 1008 may correspond to the PDCP T-reordering timer parameter. Each of the value fields may comprise an octet. For example: C0 related to PDCP T-Reordering, if set to “1”, it requires 1 octet for the timer value in ms. C1 related to RLC T-Reassembly, if set to “1”, it requires 1 octet for the timer value in ms. C2 related to RLC acknowledged mode (AM), if set to “1” it requires 1 octet for SN Size. The value fields may indicate the values to which each of the corresponding parameters is to be reconfigured.

The UE 1102 may transmit the MAC CE 1000 with the UL data 1110 on a UL TB 1114 to the base station 1104. The UL data 1110 may be arranged and/or encoded in accordance with the configuration with the reconfigured PDCP T-ordering timer parameter for the DRB when transmitted in the UL TB 1114. Accordingly, the MAC CE 1000 may indicate the reconfiguration of the PDCP T-ordering timer parameter to the setting of 40 ms of the DRB transporting the UL data 1110. Accordingly, the indication of the reconfiguration of the PDCP of the DRB may be transported in the same UL TB 1114 as the data to which the reconfiguration of the DRB is to apply.

The base station 1104 may receive the UL TB 1114 from the UE 1102. The base station 1104 may identify the MAC CE 1000 within the UL TB 1114 and determine that the PDCP T-ordering timer parameter is to be reconfigured from the MAC CE 1000. In the illustrated example, the base station 1104 may determine that the DRB is to be reconfigured with the PDCP T-ordering time parameter set to 40 ms based on the MAC CE 1000.

The base station 1104 may perform an ad-hoc DRB reconfiguration 1116 to reconfigure the base station side with the PDCP T-ordering timer parameter set to 40 ms. For example, the NW reconfigures the DRB of LCID=3 accordingly. The base station 1104 may configure the DRB with the PDCP T-ordering timer parameter set to 40 ms in the illustrated embodiment.

The base station 1104 may utilize the configuration of the DRB after reconfiguration to process the UL data 1110 received in the UL TB 1114. For example, the base station 1104 may decode the UL data 1110 in accordance with the configuration of the DRB to produce data 1118. The base station 104 may provide the data 1118 to another of the network elements, such as the core network.

A fourth example (referred to as Example 4) of inline release of a DRB after, for example, no UL data available anymore is described herein. For example, the procedure of example 4 may be performed to implement an inline release of a DRB when a UE does not have UL data to be transmitted to a base station at the time. In other instances, an inline release of a DRB may be performed based on configuration considerations. FIG. 12 illustrates an example MAC CE 1200 in accordance with some embodiments. FIG. 13 illustrates an example signal diagram 1300 corresponding to the MAC CE 1200 of FIG. 12 in accordance with some embodiments. The MAC CE 1200 and the signal diagram 1300 illustrates the fourth example in accordance with some embodiments.

The DRB release example may occur between a UE 1302 and a base station 1304. The UE 1302 may include one or more of the features of UE 102 (FIG. 1), the UE 202 (FIG. 2), and/or the UE 1600 (FIG. 16). Further, the base station 1304 may include one or more of the features of the base station 104 (FIG. 1), the base station 204 (FIG. 2), and/or the gNB 1700 (FIG. 17). In the illustrated embodiment, the UE 1302 may originate the DRB release of example 4 and the base station 1304 may receive an indication from the UE 1302 for release of the DRB. The UE 1302 and the base station 1304 may have preloaded UE contexts and/or default configurations stored as indicated by 1306. The preloaded UE contexts and/or default configurations may be for different traffic profiles and/or RF conditions. Further, the preloaded UE contexts and/or default configurations may include secure IDs. The UE 1302 may be connected to the base station 1304 as indicated by 1308.

The UE 1302 may determine that it no longer has UL data to be transmitted to the base station 1304 via the DRB. For example, the UE 1302 may have previously utilized the DRB to transmit UL data to the base station 1304. However, the UE 1302 may determine that it does not currently have UL data to be transmitted to the base station 1304. Based on the UE 1302 determining that it does not currently have UL data to be transmitted to the base station 1304, the UE may determine that the DRB is to be released.

The UE 1302 may perform an ad-hoc DRB release 1310 to release the DRB at the UE side. For example, the UE 1302 may perform the ad-hoc DRB release 1310 to release the DRB previously utilized by the UE 1302 to transmit UL data to the base station 1304.

The UE 1302 may generate the MAC CE 1200 to indicate to the base station 1304 to release the DRB. The MAC CE 1200 may include one or more of the features of the MAC CE 400 (FIG. 4). The MAC CE 1200 may be referred to as a release MAC CE. The MAC CE 1200 may include an LCID field 1202 that indicates an LC corresponding to the DRB to be released. In the illustrated embodiments, the LCID value is set to 3, and the MAC CE 1200 may indicate that an LC corresponding to the LCID value of 3 is to release the DRB.

The MAC CE 1200 may be limited to the LCID field 1202. The MAC CE 1200 including only the LCID field 1202 may indicate that the DRB of the LC corresponding to the LCID value of the LCID field 1202 is to be release in some embodiments. In other embodiments, the MAC CE 1200 may be associated with an index value, such as one of the index values of the index values 302 (FIG. 3). The index value with which the MAC CE 1200 is associated may indicate that DRB is to be released.

The UE 1302 may transmit the MAC CE 1200 on a UL TB 1312 to the base station 1304. For example, UE 1302 sends “Release MAC CE” that indicates LCID=3. The MAC CE 1200 transmitted to the base station 1304 may indicate for the base station 1304 to release the DRB.

The base station 1304 may receive the UL TB 1312 from the UE 1302. The base station 1304 may identify the MAC CE 1200 within the UL TB 1312 and determine that the DRB is to be released based on the MAC CE 1200.

The base station 1304 may perform an ad-hoc DRB release 1314 to release the DRB. For example, the NW releases the DRB of LCID=3 in the illustrated example. The base station 1304 may release the DRB based on the determination that the DRB is to be released.

While the approaches described throughout this application have been described with the UE as the originating device that generates the MAC CEs and the base station as the receiving device that receives the MAC CE, it should be understood that the base station may be the originating device and the UE may be the receiving device in other instances. In particular, the base station may perform the operations that are described throughout as being performed by the UE and the UE may perform the operations that are described throughout as being performed by the base station. For example, the base station may generate the MAC CEs and the UE may receive the MAC CE in some instances. Further, it should be understood that the base stations described throughout this disclosure may refer to nodeBs, evolved nodeBs (eNBs), and/or next generation nodeBs (gNBs) in embodiments.

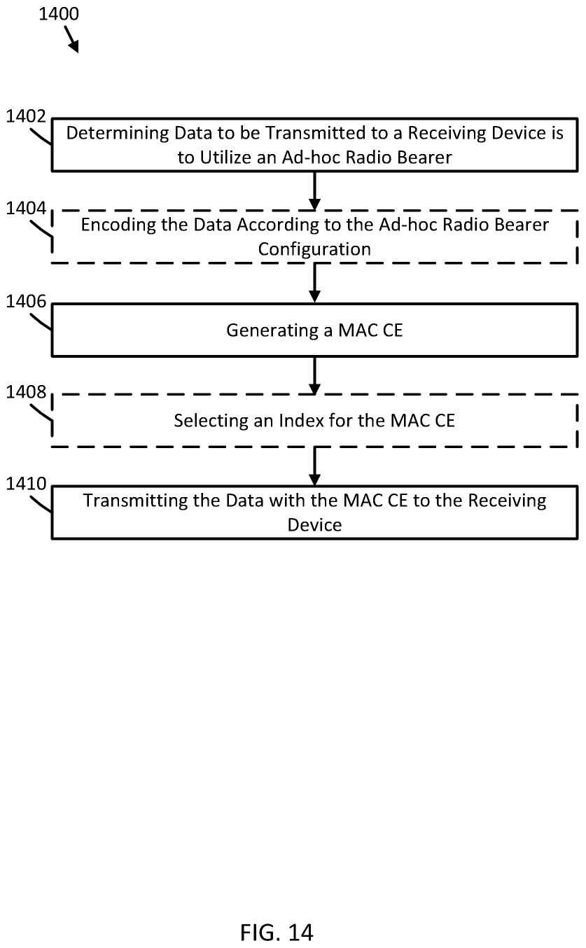

FIG. 14 illustrates an example procedure 1400 for indicating an ad-hoc radio bearer to be configured, reconfigured, or released in accordance with some embodiments. The procedure may be performed by an originating device. In some embodiments, the originating device may be a UE, such as the UE 102 (FIG. 1), the UE 202 (FIG. 2), the UE 702 (FIG. 7), the UE 902 (FIG. 9), the UE 1102 (FIG. 11), the UE 1302 (FIG. 13), and/or the UE 1600 (FIG. 16). In other embodiments, the originating device may be a base station, such as the base station 104 (FIG. 1), the base station 204 (FIG. 2), the base station 704 (FIG. 7), the base station 904 (FIG. 9), the base station 1104 (FIG. 11), the base station 1304 (FIG. 13), and/or the gNB 1700 (FIG. 17).

The procedure 1400 may include determining data to be transmitted to a receiving device is to utilize an ad-hoc radio bearer in 1402. For example, the originating device may receive data from an application and/or service. The application and/or the service may be executed by the originating device. The originating device may determine that the data is to utilize a radio bearer configured via an ad-hoc process when transmitted to the receiving device. The originating device may determine that the data is to utilize the ad-hoc radio bearer based on QoS requirements for the data, application end-to-end latency related to the data, privacy or security needs for the data, a size of the data, congestion related to the data, offloading capabilities related to the data, or RF conditions related to the data.

In some embodiments, the receiving device may be a base station, such as the base station 104, the base station 204, the base station 704, the base station 904, the base station 1104, the base station 1304, and/or the gNB 1700. For example, the receiving device may be a base station when the originating device is a UE. In other embodiments, the receiving device may be a UE, such as the UE 102, the UE 202, the UE 702, the UE 902, the UE 1102, the UE 1302, and/or the UE 1600. For example, the receiving device may be a UE when the originating device is a base station.

The procedure 1400 may further include generating a MAC CE in 1406. For example, the originating device may generate a MAC CE corresponding to the data. The MAC CE may include an indication of an LC for the ad-hoc radio bearer. In some embodiments, the MAC CE may include a context ID to indicate preconfigured DRB settings to be utilized for the ad-hoc radio bearer. The preconfigured DRB settings may be first preconfigured DRB settings in some embodiments. The MAC CE may further include an extension flag to indicate whether the MAC CE includes an additional context ID to indicate second preconfigured DRB settings for configuration of an additional ad-hoc radio bearer.

In some embodiments, the MAC CE may include a bitmap to indicate one or more parameters for the ad-hoc radio bearer and one or more values corresponding to the one or more parameters. The one or more parameters may include PDCP T-reordering, RLC T-assembly, or RLC AM. In some embodiments, the bitmap may include one or more bitmap octets. In some of these embodiments, the bitmap may include a first bitmap octet. The bitmap may further include an extension flag to indicate whether a second bitmap octet follows the first bitmap octet within the bitmap.

In some embodiments, the configuration of the ad-hoc radio bearer indicated by the MAC CE may be a release of the ad-hoc radio bearer. In some of these embodiments, the MAC CE may omit other fields related to the ad-hoc radio bearer to indicate that the ad-hoc radio bearer is to be released. In some of these embodiments, an index for the MAC CE may be to indicate that the ad-hoc radio bearer is to be released.

The procedure 1400 may further include selecting an index for the MAC CE 1408. For example, the originating device may select an index for the MAC CE generated in 1406. The index selected may indicate whether to setup, reconfigure, or release the ad-hoc radio bearer. In some embodiments, 1408 may be omitted.

The procedure 1400 may further include transmitting the data with the MAC CE to the receiving device in 1408. For example, the originating device may transmit the data with the MAC CE to the receiving device to indicate a configuration of the ad-hoc radio bearer. The data and the MAC CE may be transmitted to the receiving device in a transport block. The data may be encoded with settings of the ad-hoc radio bearer in some embodiments. In some embodiments, the data may be transmitted on the ad-hoc radio bearer being indicated to be setup or reconfigured.

While operations of the procedure 1400 are illustrated in a particular order, it should be understood that an order of the operations may be different and/or two or more of the operations may be performed concurrently in other embodiments. Further, it should be understood that one or more of the operations of the procedure 1400 may be omitted in other embodiments, and/or the operations of the procedure 1400 may be included in a larger procedure in other embodiments.

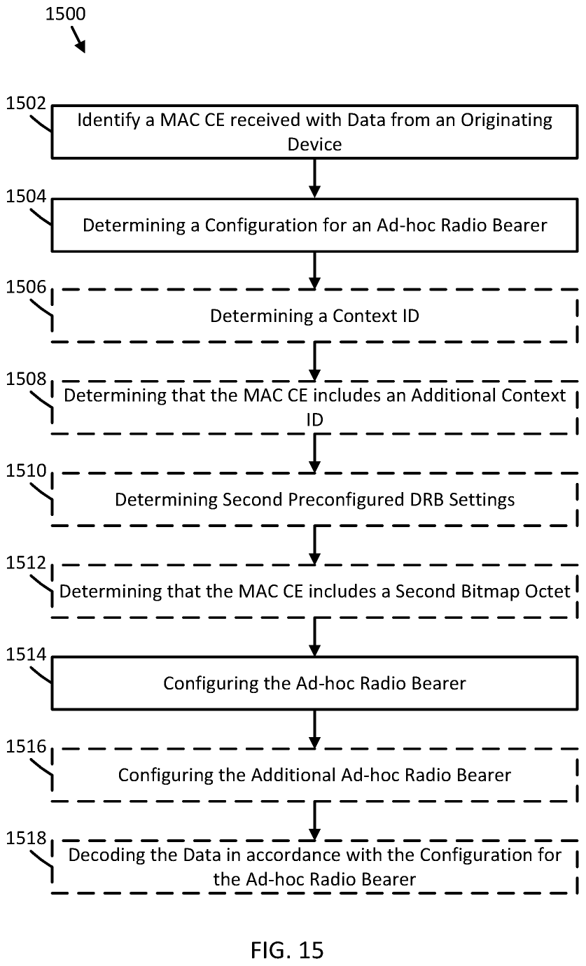

FIG. 15 illustrates an example procedure 1500 for configuring, reconfiguring, or releasing an ad-hoc radio bearer in accordance with some embodiments. The procedure may be performed by a receiving device. In some embodiments, the receiving device may be a UE, such as the UE 102 (FIG. 1), the UE 202 (FIG. 2), the UE 702 (FIG. 7), the UE 902 (FIG. 9), the UE 1102 (FIG. 11), the UE 1302 (FIG. 13), and/or the UE 1600 (FIG. 16). In other embodiments, the originating device may be a base station, such as the base station 104 (FIG. 1), the base station 204 (FIG. 2), the base station 704 (FIG. 7), the base station 904 (FIG. 9), the base station 1104 (FIG. 11), the base station 1304 (FIG. 13), and/or the gNB 1700 (FIG. 17).

The procedure 1500 may include identifying a MAC CE received with data from an originating device in 1502. For example, the receiving device may identify the MAC CE receiving from data from the originating device. The data and the MAC CE may be received in a transport block. In some embodiments, the MAC CE may include a context ID and/or an additional context ID. In some embodiments, the MAC CE may include a bitmap to indicate one or more parameters for the ad-hoc radio bearer and one or more values corresponding to the one or more parameters. The one or more parameters may include PDCP T-reordering, RLC T-reassembly, or RLC AM.

In some embodiments, the originating device may be a base station, such as the base station 104, the base station 204, the base station 704, the base station 904, the base station 1104, the base station 1304, and/or the gNB 1700. For example, the originating device may be a base station when the receiving device is a UE. In other embodiments, the originating device may be a UE, such as the UE 102, the UE 202, the UE 702, the UE 902, the UE 1102, the UE 1302, and/or the UE 1600. For example, the originating device may be a UE when the receiving device is a base station.

The procedure 1500 may include determining a configuration for an ad-hoc radio bearer in 1504. For example, the receiving device may determine a configuration for an ad-hoc radio bearer for an LC indicated by the MAC CE. In some embodiments, determining the configuration may include determining an index of the MAC CE. The index may indicate whether to setup, reconfigure, or release the ad-hoc radio bearer.

The procedure 1500 may include determining a context ID in 1506. For example, the receiving device may determine a context ID from the MAC CE. Determining the configuration of 1504 may include determining preconfigured DRB settings for configuration of the ad-hoc radio bearer based on the context ID. In some embodiments, 1506 may be omitted.

The procedure 1500 may include determining that the MAC CE includes an additional context ID in 1508. For example, the receiving device may determine that the MAC CE includes an additional context ID for configuration of an additional ad-hoc radio bearer based on an extension flag included in the MAC CE. For example, the receiving device may determine the context ID in 1506 and may then determine that the MAC CE includes a context ID in addition to the context ID determined in 1506. In some embodiments, 1508 may be omitted.

The procedure 1500 may include determining second preconfigured DRB settings in 1510. For example, the receiving device may determine second preconfigured DRB settings for configuration of the additional ad-hoc bearer based on the additional context ID from 1508. In some embodiments, 1510 may be omitted.

The procedure 1500 may include determining that the MAC CE includes a second bitmap octet in 1512. For example, in instances where the MAC CE includes a bitmap, the bitmap may include one or more bitmap octets to indicate one or more parameters, including a first bitmap octet that indicates a first set of one or more parameters. The MAC CE may further include one or more sets of one or more values corresponding sets of one or more parameters, including a first set of one or more values corresponding to the first set of one or more parameters. The receiving device may determine, based on an extension flag in the MAC CE, that the MAC CE includes a second bitmap octet and a second set of one or more values corresponding to a second set of one or more parameters corresponding to the second bitmap octet. In some embodiments, 1512 may be omitted.

The procedure 1500 may include configuring the ad-hoc radio bearer in 1514. For example, the receiving device may configure the ad-hoc radio bearer in accordance with the configuration determined in 1504. In some embodiments where the MAC CE includes a bitmap, configuring the ad-hoc radio bearer may include reconfiguring the one or more parameters corresponding to the bitmap for the ad-hoc parameter with the one or more values corresponding to the one or more parameters. In some embodiments where the MAC CE is determined to include a second bitmap octet and a second set of one or more values, configuring the ad-hoc radio bearer may include reconfiguring the second set of one or more parameters for the ad-hoc radio bearer with the second set of one or more values.

The procedure 1500 may include configuring the additional ad-hoc radio bearer in 1516. For example, the receiving device may configure the additional ad-hoc radio bearer in accordance with the second preconfigured DRB settings determined in 1510. In some embodiments, 1516 may be omitted.

The procedure 1500 may include the proper decoding of the headers the data in 1518. For example, the receiving device may decode the data in accordance with the configuration determined in 1504. In some embodiments, 1518 may be omitted.

While operations of the procedure 1500 are illustrated in a particular order, it should be understood that an order of the operations may be different and/or two or more of the operations may be performed concurrently in other embodiments. Further, it should be understood that one or more of the operations of the procedure 1500 may be omitted in other embodiments, and/or the operations of the procedure 1500 may be included in a larger procedure in other embodiments.

The approaches described may have one or more benefits. Some of the benefits may include reduced signalling overhead (cell capacity, latency). Instead of heavy signalling via NAS or RRC the UE may select from predefined sets of DRB settings (i.e., for service data adaptation protocol (SDAP), PDCP, RLC, logical channel prioritization (LCP)) and establish this bearer in an ad-hoc manner (e.g., RLC unacknowledged mode (UM)/AM, sequence number (SN) size, integrity/ciphering, timers, ooo-delivery, robust header compression (ROHC) profiles, etc.). More dynamic refinement of the settings becomes possible with these lean approaches.

Further the benefits may include more application-awareness and more UE intelligence. UE has more control based on Application needs, for example inline signalling of release can be useful for power-saving (compared to RRC inactivity timer). The UE may enter idle mode (and save power) immediately after the NW acknowledges this message, saving approximately 10 seconds of connected mode.

FIG. 16 illustrates an example UE 1600 in accordance with some embodiments. The UE 1600 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1600 may be a RedCap UE or NR-Light UE.

The UE 1600 may include processors 1604, RF interface circuitry 1608, memory/storage 1612, user interface 1616, sensors 1620, driver circuitry 1622, power management integrated circuit (PMIC) 1624, antenna structure 1626, and battery 1628. The components of the UE 1600 may be implemented as integrated circuits (ICs), portions thereof, discrete electronic devices, or other modules, logic, hardware, software, firmware, or a combination thereof. The block diagram of FIG. 16 is intended to show a high-level view of some of the components of the UE 1600. However, some of the components shown may be omitted, additional components may be present, and different arrangement of the components shown may occur in other implementations.

The components of the UE 1600 may be coupled with various other components over one or more interconnects 1632, which may represent any type of interface, input/output, bus (local, system, or expansion), transmission line, trace, optical connection, etc. that allows various circuit components (on common or different chips or chipsets) to interact with one another.

The processors 1604 may include processor circuitry such as, for example, baseband processor circuitry (BB) 1604A, central processor unit circuitry (CPU) 1604B, and graphics processor unit circuitry (GPU) 1604C. The processors 1604 may include any type of circuitry or processor circuitry that executes or otherwise operates computer-executable instructions, such as program code, software modules, or functional processes from memory/storage 1612 to cause the UE 1600 to perform operations as described herein.

In some embodiments, the baseband processor circuitry 1604A may access a communication protocol stack 1636 in the memory/storage 1612 to communicate over a 3GPP compatible network. In general, the baseband processor circuitry 1604A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1608.

The baseband processor circuitry 1604A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1612 may include one or more non-transitory, computer-readable media that includes instructions (for example, communication protocol stack 1636) that may be executed by one or more of the processors 1604 to cause the UE 1600 to perform various operations described herein. The memory/storage 1612 include any type of volatile or non-volatile memory that may be distributed throughout the UE 1600. In some embodiments, some of the memory/storage 1612 may be located on the processors 1604 themselves (for example, L1 and L2 cache), while other memory/storage 1612 is external to the processors 1604 but accessible thereto via a memory interface. The memory/storage 1612 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1608 may include transceiver circuitry and radio frequency front module (RFEM) that allows the UE 1600 to communicate with other devices over a radio access network. The RF interface circuitry 1608 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1626 and proceed to filter and amplify (with a low-noise amplifier) the signal. The signal may be provided to a receiver of the transceiver that down-converts the RF signal into a baseband signal that is provided to the baseband processor of the processors 1604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1626.

In various embodiments, the RF interface circuitry 1608 may be configured to transmit/receive signals in a manner compatible with NR access technologies.

The antenna 1626 may include antenna elements to convert electrical signals into radio waves to travel through the air and to convert received radio waves into electrical signals. The antenna elements may be arranged into one or more antenna panels. The antenna 1626 may have antenna panels that are omnidirectional, directional, or a combination thereof to enable beamforming and multiple input, multiple output communications. The antenna 1626 may include microstrip antennas, printed antennas fabricated on the surface of one or more printed circuit boards, patch antennas, phased array antennas, etc. The antenna 1626 may have one or more panels designed for specific frequency bands including bands in FR1 or FR2.

The user interface circuitry 1616 includes various input/output (I/O) devices designed to enable user interaction with the UE 1600. The user interface 1616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1600.

The sensors 1620 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1622 may include software and hardware elements that operate to control particular devices that are embedded in the UE 1600, attached to the UE 1600, or otherwise communicatively coupled with the UE 1600. The driver circuitry 1622 may include individual drivers allowing other components to interact with or control various input/output (I/O) devices that may be present within, or connected to, the UE 1600. For example, driver circuitry 1622 may include a display driver to control and allow access to a display device, a touchscreen driver to control and allow access to a touchscreen interface, sensor drivers to obtain sensor readings of sensor circuitry 1620 and control and allow access to sensor circuitry 1620, drivers to obtain actuator positions of electro-mechanic components or control and allow access to the electro-mechanic components, a camera driver to control and allow access to an embedded image capture device, audio drivers to control and allow access to one or more audio devices.

The PMIC 1624 may manage power provided to various components of the UE 1600. In particular, with respect to the processors 1604, the PMIC 1624 may control power-source selection, voltage scaling, battery charging, or DC-to-DC conversion.

In some embodiments, the PMIC 1624 may control, or otherwise be part of, various power saving mechanisms of the UE 1600. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1600 may power down for brief intervals of time and thus save power. If there is no data traffic activity for an extended period of time, then the UE 1600 may transition off to an RRC_Idle state, where it disconnects from the network and does not perform operations such as channel quality feedback, handover, etc. The UE 1600 goes into a very low power state and it performs paging where again it periodically wakes up to listen to the network and then powers down again. The UE 1600 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1628 may power the UE 1600, although in some examples the UE 1600 may be mounted deployed in a fixed location, and may have a power supply coupled to an electrical grid. The battery 1628 may be a lithium ion battery, a metal-air battery, such as a zinc-air battery, an aluminum-air battery, a lithium-air battery, and the like. In some implementations, such as in vehicle-based applications, the battery 1628 may be a typical lead-acid automotive battery.

FIG. 17 illustrates an example gNB 1700 in accordance with some embodiments. The gNB 1700 may include processors 1704, RF interface circuitry 1708, core network (CN) interface circuitry 1712, memory/storage circuitry 1716, and antenna structure 1726.

The components of the gNB 1700 may be coupled with various other components over one or more interconnects 1728.

The processors 1704, RF interface circuitry 1708, memory/storage circuitry 1716 (including communication protocol stack 1710), antenna structure 1726, and interconnects 1728 may be similar to like-named elements shown and described with respect to FIG. 16.

The CN interface circuitry 1712 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1700 via a fiber optic or wireless backhaul. The CN interface circuitry 1712 may include one or more dedicated processors or FPGAs to communicate using one or more of the aforementioned protocols. In some implementations, the CN interface circuitry 1712 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating an originating device, comprising determining data to be transmitted to a receiving device is to utilize an ad-hoc radio bearer, generating a medium access control (MAC) control element (CE) corresponding to the data, the MAC CE including an indication of a logical channel (LC) for the ad-hoc radio bearer, and transmitting the data with the MAC CE to the receiving device to indicate a configuration of the ad-hoc radio bearer.

Example 2 may include the method of claim 1, wherein the data is encoded with settings for the ad-hoc radio bearer.

Example 3 may include the method of claim 1, wherein the data is transmitted on the ad-hoc radio bearer.

Example 4 may include the method of example 1, wherein the MAC CE further includes a context identifier (ID) to indicate preconfigured data radio bearer (DRB) settings to be utilized for the ad-hoc radio bearer.

Example 5 may include the method of example 4, wherein the preconfigured DRB settings are first preconfigured DRB settings, wherein the MAC CE further includes an extension flag to indicate whether the MAC CE includes an additional context ID to indicate second preconfigured DRB settings for configuration of an additional ad-hoc radio bearer.

Example 6 may include the method of example 1, wherein the MAC CE further includes a bitmap to indicate one or more parameters for the ad-hoc radio bearer and one or more values corresponding to the one or more parameters.

Example 7 may include the method of example 6, wherein the one or more parameters include packet data convergence protocol (PDCP) T-reordering, radio link control (RLC) T-reassembly, or RLC acknowledged mode (AM).

Example 8 may include the method of example 6, wherein the bitmap includes one or more bitmap octets, wherein the bitmap includes a first bitmap octet, and wherein the bitmap includes an extension flag to indicate whether a second bitmap octet follows the first bitmap octet within the bitmap.

Example 9 may include the method of example 1, wherein the configuration of the ad-hoc radio bearer indicated by the MAC CE is a release of the ad-hoc radio bearer, and wherein the MAC CE omits other fields related to the ad-hoc radio bearer to indicate that the ad-hoc radio bearer is to be released.

Example 10 may include the method of example 1, wherein the configuration of the ad-hoc radio bearer indicated by the MAC CE is a release of the ad-hoc radio bearer, and wherein an index for the MAC CE is to indicate that the ad-hoc radio bearer is to be released.

Example 11 may include the method of example 1, further comprising selecting an index for the MAC CE, wherein the index is to indicate whether to setup, reconfigure, or release the ad-hoc radio bearer.

Example 12 may include the method of example 1, wherein determining the data is to utilize the ad-hoc radio bearer includes determining the data is to utilize the ad-hoc radio bearer based at least in part on quality of service (QoS) requirements for the data, application end-to-end latency related to the data, privacy or security needs for the data, a size of the data, an amount of congestion related to the data, offloading capabilities related to the data, or radio frequency (RF) conditions related to the data.

Example 13 may include the method of example 1, wherein the data and the MAC CE are transmitted to the receiving device in a transport block.

Example 14 may include the method of example 1, wherein the originating device is a user equipment (UE), and wherein the receiving device is a base station.

Example 15 may include the method of example 1, wherein the originating device is a base station, and wherein the receiving device is a user equipment (UE).

Example 16 may include a method of operating a receiving device, comprising identifying a medium access control (MAC) control element (CE) received with data from an originating device, determining a configuration for an ad-hoc radio bearer for a logical channel (LC) indicated by the MAC CE, and configuring the ad-hoc radio bearer in accordance with the configuration.

Example 17 may include the method of example 16, further comprising decoding the data in accordance with the configuration.

Example 18 may include the method of example 16, further comprising determining a context ID from the MAC CE, wherein determining the configuration includes determining preconfigured data radio bearer (DRB) settings for configuration of the ad-hoc radio bearer based at least in part on the context ID.

Example 19 may include the method of example 18, wherein the preconfigured DRB settings are first preconfigured data radio bearer settings, and wherein the method further comprises determining that the MAC CE includes an additional context ID for configuration of an additional ad-hoc radio bearer based at least in part on an extension flag included in the MAC CE, determining second preconfigured DRB settings for configuration of the additional ad-hoc radio bearer based at least in part on the additional context ID, and configuring the additional ad-hoc radio bearer in accordance with the second preconfigured DRB settings.

Example 20 may include the method of example 16, wherein the MAC CE includes a bitmap to indicate one or more parameters for the ad-hoc radio bearer and one or more values corresponding to the one or more parameters, wherein configuring the ad-hoc radio bearer includes reconfiguring the one or more parameters for the ad-hoc radio bearer with the one or more values.

Example 21 may include the method of example 20, wherein the one or more parameters include packet data convergence protocol (PDCP) T-reordering, radio link control (RLC) T-reassembly, or RLC acknowledged mode (AM).

Example 22 may include the method of example 20, wherein the bitmap includes one or more bitmap octets, wherein the bitmap includes a first bitmap octet, wherein the one or more parameters is a first set of one or more parameters, wherein the one or more values is a first set of one or more values, and wherein the method further comprises determining, based at least in part on an extension flag in the MAC CE, that the MAC CE includes a second bitmap octet and a second set of one or more values corresponding to a second set of one or more parameters corresponding to the second bitmap octet, wherein configuring the ad-hoc radio bearer further includes reconfiguring the second set of one or more parameters for the ad-hoc radio bearer with the second set of one or more values.

Example 23 may include the method of example 16, wherein determining the configuration includes determining an index of the MAC CE, wherein the index is to indicate whether to setup, reconfigure, or release the ad-hoc radio bearer.

Example 24 may include the method of example 16, wherein the data and the MAC CE are received in a transport block.

Example 25 may include the method of example 16, wherein the receiving device is a base station, and wherein the originating device is a user equipment (UE).

Example 26 may include the method of example 16, wherein the receiving device is a user equipment (UE), and wherein the originating device is a base station.

Example 27 may include an apparatus comprising means to perform one or more elements of a method described in or related to any of examples 1-26, or any other method or process described herein.

Example 28 may include one or more non-transitory computer-readable media comprising instructions to cause an electronic device, upon execution of the instructions by one or more processors of the electronic device, to perform one or more elements of a method described in or related to any of examples 1-26, or any other method or process described herein.

Example 29 may include an apparatus comprising logic, modules, or circuitry to perform one or more elements of a method described in or related to any of examples 1-26, or any other method or process described herein.

Example 30 may include a method, technique, or process as described in or related to any of examples 1-26, or portions or parts thereof.

Example 31 may include an apparatus comprising: one or more processors and one or more computer-readable media comprising instructions that, when executed by the one or more processors, cause the one or more processors to perform the method, techniques, or process as described in or related to any of examples 1-26, or portions thereof.

Example 32 may include a signal as described in or related to any of examples 1-26, or portions or parts thereof.

Example 33 may include a datagram, information element, packet, frame, segment, PDU, or message as described in or related to any of examples 1-26, or portions or parts thereof, or otherwise described in the present disclosure.

Example 34 may include a signal encoded with data as described in or related to any of examples 1-26, or portions or parts thereof, or otherwise described in the present disclosure.

Example 35 may include a signal encoded with a datagram, IE, packet, frame, segment, PDU, or message as described in or related to any of examples 1-26, or portions or parts thereof, or otherwise described in the present disclosure.

Example 36 may include an electromagnetic signal carrying computer-readable instructions, wherein execution of the computer-readable instructions by one or more processors is to cause the one or more processors to perform the method, techniques, or process as described in or related to any of examples 1-26, or portions thereof.

Example 37 may include a computer program comprising instructions, wherein execution of the program by a processing element is to cause the processing element to carry out the method, techniques, or process as described in or related to any of examples 1-26, or portions thereof.

Example 38 may include a signal in a wireless network as shown and described herein.

Example 39 may include a method of communicating in a wireless network as shown and described herein.

Example 40 may include a system for providing wireless communication as shown and described herein.

Example 41 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions that, when executed by one or more processors, cause an originating device, comprising:
determine data to be transmitted to a receiving device is to utilize an ad-hoc radio bearer;
generate a medium access control (MAC) control element (CE) corresponding to the data, the MAC CE including an indication of a logical channel (LC) for the ad-hoc radio bearer; and
transmit the data with the MAC CE to the receiving device to indicate a configuration of the ad-hoc radio bearer.

2. The one or more non-transitory computer-readable media of claim 1, wherein the data is encoded with settings for the ad-hoc radio bearer.

3. The one or more non-transitory computer-readable media of claim 1, wherein the data is transmitted on the ad-hoc radio bearer.

4. The one or more non-transitory computer-readable media of claim 1, wherein the MAC CE further includes a context identifier (ID) to indicate preconfigured data radio bearer (DRB) settings to be utilized for the ad-hoc radio bearer.

5. The one or more non-transitory computer-readable media of claim 4, wherein the preconfigured DRB settings are first preconfigured DRB settings, wherein the MAC CE further includes an extension flag to indicate whether the MAC CE includes an additional context ID to indicate second preconfigured DRB settings for configuration of an additional ad-hoc radio bearer.

6. The one or more non-transitory computer-readable media of claim 1, wherein the MAC CE further includes a bitmap to indicate one or more parameters for the ad-hoc radio bearer and one or more values corresponding to the one or more parameters.

7. The one or more non-transitory computer-readable media of claim 1, wherein the configuration of the ad-hoc radio bearer indicated by the MAC CE is a release of the ad-hoc radio bearer, and wherein the MAC CE omits other fields related to the ad-hoc radio bearer to indicate that the ad-hoc radio bearer is to be released.

8. The one or more non-transitory computer-readable media of claim 1, wherein the configuration of the ad-hoc radio bearer indicated by the MAC CE is a release of the ad-hoc radio bearer, and wherein an index for the MAC CE is to indicate that the ad-hoc radio bearer is to be released.

9. The one or more non-transitory computer-readable media of claim 1, wherein the instructions, when executed by the one or more processors, further cause the originating device to select an index for the MAC CE, wherein the index is to indicate whether to setup, reconfigure, or release the ad-hoc radio bearer.

10. The one or more non-transitory computer-readable media of claim 1, wherein to determine the data is to utilize the ad-hoc radio bearer includes determine the data is to utilize the ad-hoc radio bearer based at least in part on quality of service (QoS) requirements for the data, application end-to-end latency related to the data, privacy or security needs for the data, a size of the data, an amount of congestion related to the data, offloading capabilities related to the data, or radio frequency (RF) conditions related to the data.

11. The one or more non-transitory computer-readable media of claim 1, wherein the data and the MAC CE are transmitted to the receiving device in a transport block.

12. The one or more non-transitory computer-readable media of claim 1, wherein the originating device is a user equipment (UE), and wherein the receiving device is a base station.

13. The one or more non-transitory computer-readable media of claim 1, wherein the originating device is a base station, and wherein the receiving device is a user equipment (UE).

14. A receiving device, comprising:
memory to store a configuration for an ad-hoc radio bearer; and
one or more processors coupled to the memory, the one or more processors to:
identify a medium access control (MAC) control element (CE) received with data from an originating device;
determine the configuration for the ad-hoc radio bearer for a logical channel (LC) indicated by the MAC CE; and
configure the ad-hoc radio bearer in accordance with the configuration.

15. The receiving device of claim 14, wherein the one or more processors are further to decode the data in accordance with the configuration.

16. The receiving device of claim 14, wherein the one or more processors are further to:
determine a context ID from the MAC CE, wherein to determine the configuration includes to determine preconfigured data radio bearer (DRB) settings for configuration of the ad-hoc radio bearer based at least in part on the context ID.

17. The receiving device of claim 16, wherein the preconfigured DRB settings are first preconfigured data radio bearer settings, and wherein the one or more processors are further to:
determine that the MAC CE includes an additional context ID for configuration of an additional ad-hoc radio bearer based at least in part on an extension flag included in the MAC CE;
determine second preconfigured DRB settings for configuration of the additional ad-hoc radio bearer based at least in part on the additional context ID; and
configure the additional ad-hoc radio bearer in accordance with the second preconfigured DRB settings.

18. The receiving device of claim 14, wherein the MAC CE includes a bitmap to indicate one or more parameters for the ad-hoc radio bearer and one or more values corresponding to the one or more parameters, wherein to configure the ad-hoc radio bearer includes to reconfigure the one or more parameters for the ad-hoc radio bearer with the one or more values.

19. The receiving device of claim 18, wherein the one or more parameters include packet data convergence protocol (PDCP) T-reordering, radio link control (RLC) T-reassembly, or RLC acknowledged mode (AM).

20. The receiving device of claim 18, wherein the bitmap includes one or more bitmap octets, wherein the bitmap includes a first bitmap octet, wherein the one or more parameters is a first set of one or more parameters, wherein the one or more values is a first set of one or more values, and wherein the one or more processors are further to:
determine, based at least in part on an extension flag in the MAC CE, that the MAC CE includes a second bitmap octet and a second set of one or more values corresponding to a second set of one or more parameters corresponding to the second bitmap octet, wherein to configure the ad-hoc radio bearer further includes to reconfigure the second set of one or more parameters for the ad-hoc radio bearer with the second set of one or more values.
